(19) United States
(12) Patent Application Publication
(10) Pub. No.: US 2023/0222378 A1
(43) Pub. Date: Jul. 13, 2023

(54) METHOD AND SYSTEM FOR EVALUATING FAIRNESS OF MACHINE LEARNING MODEL

(71) Applicants: Vittorio ROMANIELLO, Vancouver (CA); Mohit BAJAJ, Vancouver (CA); Gursimran SINGH, Delta (CA); Lingyang CHU, Burnaby (CA); Zirui ZHOU, Surrey (CA); Lanjun WANG, Markham (CA); Yong ZHANG, Richmond (CA)

(72) Inventors: Vittorio ROMANIELLO, Vancouver (CA); Mohit BAJAJ, Vancouver (CA); Gursimran SINGH, Delta (CA); Lingyang CHU, Burnaby (CA); Zirui ZHOU, Surrey (CA); Lanjun WANG, Markham (CA); Yong ZHANG, Richmond (CA)

(21) Appl. No.: 17/571,198

(22) Filed: Jan. 7, 2022

(51) Int. Cl. G06N 20/00

(52) U.S. Cl. CPC G06N 20/00

(57) ABSTRACT

The present disclosure provides a method and system for evaluating a machine learning model using an evaluation dataset for the machine learning model. The evaluation dataset includes for each entity in a group of entities: (i) an ordered set of attribute values for the entity, each attribute value corresponding to a respective attribute in a set of attributes that is common for all of the entities in the group of entities, and (ii) an outcome prediction generated for the entity by the machine learning model based on the ordered set of attribute values for the entity, wherein the outcome prediction generated for each entity is either a first outcome or a second outcome. Based on the evaluation dataset, using an optimization process, respective importance values are computed for the attributes, the respective importance values indicating attributes that are most responsible for the machine learning model predicting a first outcome.

### FIELD

This disclosure relates to method and systems for evaluating machine learning models and in particular for evaluating the fairness of machine learning models.

### BACKGROUND

Machine learning (ML) models are increasingly used as a tool when making recommendations or decisions that can impact individual entities. For example, lending institutions such as banks may rely on ML models that use a client’s financial and personal data to predict eligibility for the loans, organizations may rely on ML models that aid in making hiring decisions based on a candidate’s data and profile, and courts may rely on ML models to decide parole eligibility for a prisoner based on their personal information.

Training datasets that are used to train ML models to make predictions in respect of individuals typically include a set of values for multiple attributes (also referred to as features) for each of the individuals. For example, a lending institution may use a ML model, which has been trained to predict eligibility for loans, to generate loan recommendations for individuals that may rely on a set of attributes that includes attributes such as a person’s age, gender, salary, expenses, credit score, education, and employment, among other things. A ML model, when trained using such a training dataset, can become biased with respect to a subset of attributes of the multiple attributes for the individuals such as gender, age, etc. This biasing may be the result of strong correlation of the subset of attributes with other attributes such as salary and education. The biasing may lead to discrimination against individuals that correspond to certain values for subset of attributes responsible for the biasing. For instance, if an ML model generates loan recommendations that loans be granted to 70% of individuals (e.g. loan applicants) in age range 40-50 but only 40% of the individuals (e.g. loan applicants) in age range 30-40, the ML model may be perceived as discriminating, based on the “age” attribute, against the age group 30-40. This discrimination may not comply with fairness standards of the lending institution (for examples, a standards that may be part of environmental, social and governance (ESG) policies of the lending institution) and thus it is critical for the institution to be aware of potentially discriminatory or unfair ML models in advance of deployment the ML models, or as soon as practical following deployment of the ML models.

A number of solutions have been proposed for evaluating the fairness of ML models, however known solutions suffer from one or more of the following deficiencies. First, at least some known solutions are only able to evaluate fairness in the context of attributes represented using categorical variables. As a result, any attributes represented using continuous variables have to be transformed to categorical variables, which adds processing steps (thereby reducing system efficiency) and can reduce the accuracy of predictions generated by ML models. Secondly, some solutions use approximations to enable some combinations of categories to be skipped, such that not all combinations of categories are used to evaluate the fairness of an ML model. Further, some solutions require advance input of target attributes that are to be used for evaluating the fairness of a ML model, with the result that some unfair attributes may be overlooked when evaluating the fairness of a ML model or the solution will have to be repeated several times using different target attributes.

Accordingly, there is a need for systems for evaluating fairness of ML models and methods that can efficiently evaluate the fairness of ML models without requiring that target combinations of sensitive attributes be predefined. There is also a need for such systems and methods that can accurately and efficiently process attributes represented using continuous variables (“continuous variable attributes”).

### SUMMARY

According to a first example aspect of the disclosure is a computer-implemented method for evaluating a machine learning model. The computer-implemented method includes receiving an evaluation dataset for the machine learning model, the evaluation dataset comprising, for each entity in a group of entities: (i) an ordered set of attribute values for the entity, each attribute value corresponding to a respective attribute in a set of attributes that is common for all of the entities in the group of entities, and (ii) an outcome prediction generated for the entity by the machine learning model based on the ordered set of attribute values for the entity, wherein the outcome prediction generated for each entity is either a first outcome or a second outcome. The computer-implemented method also includes computing, based on the evaluation dataset, using an optimization process, respective importance values for the attributes, the respective importance values indicating respective influences of the attributes on a probability of the machine learning model predicting a first outcome, and outputting at least some of the importance values for the attributes as an evaluation metric indicating a fairness of the machine learning model.

In at least some examples of the computer-implemented method, computing the importance values using an optimization process enables the fairness of a ML model to be evaluated through an efficient, continuous optimization process that can be efficiently scaled to large datasets with large number of attributes. When compared to known solutions, the disclosed computer-implemented method may, in some scenarios, enable a computer system to generate a more optimal solution, thereby enabling the computer system to operate in an improved manner. In some examples, fewer computational resources may be required when compared to known solutions as the disclosed evaluation solution is able to identify potentially discriminating categories without being pre-instructed to focus on a sub-group of categories, thereby reducing an overall number of computer resources required to accurately identify attributes that cause discrimination.

In at least some examples of the computer-implemented method, respective importance values are computed with an objective of maximizing sizes of both a first sub-group and a second sub-group of the group of entities such that a discrimination metric for the machine learning model between the first sub-group and the second sub-group achieves a pre-defined discrimination criteria, wherein membership of the first sub-group and the second sub-group is based on the respective importance values. In some examples, the first sub-group excludes any entities that are members of the second sub-group and the first sub-group and second sub-group collectively include all entities in the group of entities.

In at least some examples of the computer-implemented method, computing the respective importance values comprises: initializing the respective importance values; repeating the optimization process until a predefined completion criteria is achieved, the optimization process comprising: (i) computing membership of a first sub-group and a second sub-group of the group of entities based on predicting, for each entity in the group of entities, a membership probability that the entity belongs to the first sub-group rather than the second sub-group, the membership probability for each entity being based on the ordered set of attribute values for the entity and the respective importance values for the attributes; (ii) computing, for the first sub-group, a first metric indicating a relative quantity of members of the first sub-group for which the machine learning model has predicted the first outcome; (iii) computing, for the second sub-group, a second metric indicating a relative quantity of members of the second sub-group for which the machine learning model has predicted the first outcome; and (iv) updating the respective importance values with an objective of maximizing the membership of both the first sub-group and the second sub-group with a difference between the first metric and the second metric achieving at least pre-defined discrimination threshold metric.

In at least some examples of the computer-implemented method, when the predefined completion criteria is achieved, the method includes outputting a final membership of the first sub-group and the second sub-group that includes an identification of the entities of the first sub-group and the second sub-group, respectively; and outputting, as a discrimination metric, the difference between the first metric and the second metric for the final membership.

In at least some examples of the computer-implemented method, outputting at least some of the importance values comprises outputting a subset of the importance values that consist of a predefined number of the importance values ranked according to highest value, the method further comprising receiving the predefined number as an input.

In at least some examples of the computer-implemented method, the importance values are continuous variables on a predefined continuous scale.

In at least some examples of the computer-implemented method, the attributes include both discrete variable attributes and continuous variable attributes.

In at least some examples of the computer-implemented method, the evaluation dataset includes a tabular data structure, with the entities in the group of entities represented in a respective row, and each attribute represented in a respective column.

In at least some examples of the computer-implemented method, the entities are set of human individuals, the attributes correspond to attributes of the human individuals, the first outcome is a preferred outcome for the human entities, the second outcome is a non-preferred outcome, and the method further comprises: determining, based on the output importance values for the attributes, if the machine learning model unfairly discriminates between human individuals based on one or more of the attributes; and when the machine learning model is determined to unfairly discriminate, outputting an indication thereof.

In at least some examples of the computer-implemented method, the respective importance values are computed with an objective of maximizing a discrimination metric that corresponds to a difference between a relative quantity of entities of the group of entities included within a first sub-group having the first outcome predicted by the machine learning model and a relative quantity of entities included within a second sub-group having the first outcome predicted by the machine learning, wherein membership of the first sub-group and the second sub-group is based on the respective importance values.

In at least some examples of the computer-implemented method, computing the respective importance values comprises: initializing the respective importance values; repeating the optimization process until a predefined completion criteria is achieved, the optimization process comprising: (i) computing membership of a first sub-group and a second sub-group of the group of entities based on predicting, for each entity in the group of entities, a membership probability that the entity belongs to the first sub-group rather than the second sub-group, the membership probability for each entity being based on the ordered set of attribute values for the entity and the respective importance values for the attributes; (ii) computing, for the first sub-group, a first metric indicating a relative quantity of members of the first sub-group for which the machine learning model has predicted the first outcome; (iii) computing, for the second sub-group, a second metric indicating a relative quantity of members of the second sub-group for which the machine learning model has predicted the first outcome; and (iv) updating the respective importance values with an objective of maximizing the difference between the first metric and the second metric with membership of both the first sub-group and the second sub-group achieving a pre-defined size constraint.

In at least some examples of the computer-implemented method, the computer-implemented method further includes, when the predefined completion criteria is achieved: outputting a final membership of the first sub-group and the second sub-group that includes an identification of the entities of the first sub-group and the second sub-group, respectively; and outputting, as the discrimination metric, the difference between the first metric and the second metric for the final membership.

According to a further example aspect is a system for evaluating a machine learning model, comprising one or more processors, and one or more memories storing executable instructions that when executed by the one or more processors cause the system to process an evaluation dataset for the machine learning model according to any one of the preceding methods.

According to a further example aspect is a non-transitory computer readable medium storing computer executable instructions for evaluating a machine learning model by processing an evaluation dataset for the machine learning model according to any one of the preceding computer-implemented methods.

### BRIEF DESCRIPTION OF THE DRAWINGS

Reference will now be made, by way of example, to the accompanying drawings which show example embodiments of the present disclosure, and in which:

FIG. 1 is a block diagram illustrating a machine learning (ML) model;

FIG. 2 illustrates an example format of a model fairness evaluation dataset for the ML model of FIG. 1;

FIG. 3 illustrates a block diagram of a system that includes an ML model fairness evaluation module for evaluating fairness of the ML model of FIG. 1, according to example embodiments;

FIG. 4 illustrates a flow diagram of actions performed by the ML model fairness evaluation module of FIG. 3, according to example embodiments corresponding to a first optimization process;

FIG. 5 illustrates a flow diagram of actions performed by the ML model fairness evaluation module of FIG. 3, according to further example embodiments corresponding to an alternative optimization process; and

FIG. 6 is a block diagram illustrating of a computer system for implementing the evaluation module of FIG. 3, according to example embodiments.

### DESCRIPTION OF EXAMPLE EMBODIMENTS

Example embodiments of systems, computer-implemented methods and computer program products for evaluating the fairness of a machine learning (ML) model.

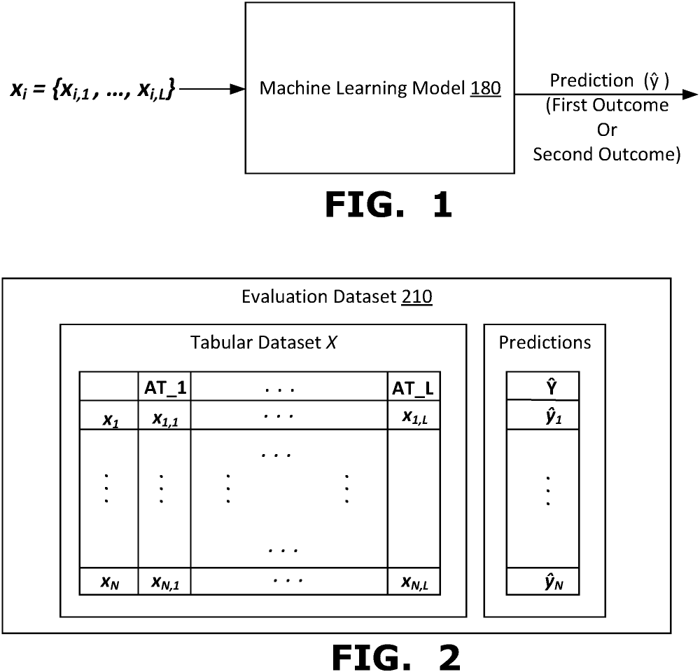

To provide context, FIG. 1 illustrates an example of an ML model 180 that has been trained to predict an outcome ŷ for an input tensor xᵢ that is an ordered set of attribute values xᵢ = {x_{i,1}, ...,x_{i,L}} for an individual entity i. In an example embodiment, the input tensor xᵢ, (otherwise referred to as attribute tensor xᵢ) represents an individual entity i, for example an individual human person, and the elements of the ordered set of attribute values {x_{i,1}, ..., x_{i,L}} indicate respective values for a set of attributes {AT_1, ... , AT_L} for the individual entity i. By way of example, a set of attributes {AT_1, ... , AT_L} for an individual entity i that is a person can include one or more attributes that can indicate personal characteristics or features such as: person’s age, gender identity, salary, passive income, assets, expenses, debt, credit score, education, address, nationality, residential address, employment address, employer, job title, medical status, weight, height, marital status, and number of dependents, among other things. Some of the attributes in a set of attributes {AT_1, ... , AT_L} for an individual entity i may be continuous variables, for example weight and passive income, and other attributes in a set of attributes {AT_1, ... , AT_L} for an individual entity i may be discrete or categorical variables, for example age (in discrete years), gender identity and nationality.

The ML model 180 has been trained to perform a binary prediction task in respect of the individual entity i. In particular, ML model 180 has been trained to map the input tensor xᵢ that is an ordered set of attribute values {x_{i,1}, ...,x_{i,L}} for an individual entity i to a prediction outcome ŷᵢ that is either a first outcome or a second outcome. For example, the ML model 180 may be trained to generate a prediction outcome ŷ indicating either that the individual entity i be approved for a loan or a job interview (i.e., a first outcome ŷ=1 that is objectively considered to be a preferred outcome) or that the individual entity i be denied a loan or a job interview (i.e., a second outcome ŷ=0 that is objectively considered to be a non-preferred outcome).

Typically, the trained ML model 180 will strongly correlate at least some of the attributes with either a preferred or non-preferred outcome. For example, in the case of an ML model 180 that has been trained to recommend approval or denial of a loan for an individual entity i (e.g. a loan applicant), a high value for the “credit score” attribute may be expected to correlate heavily with loan approval (the preferred outcome). However, scenarios can arise where the trained ML model 180 ends up leaning a bias that is inaccurate or unintentional, such that the ML model 180 discriminates against loan applicants based on sensitive categories, for example gender identity (a categorical attribute) or weight (a continuous variable). In such examples of unexpected bias, further examination of the ML model 180 is desired to ensure that the ML model 180 has not learned an inappropriate bias that renders the ML model 180 unfair or discriminatory. For example, a discriminatory or unfair ML model 180 can be a ML model that makes a number of first outcome predictions (for example preferred outcome decisions) for one particular group of entities, based on one or more sensitive attributes of the group, that exceeds the number of first outcome predictions made for another particular group by a predetermined discrimination metric threshold.

Referring to FIG. 2, as a pre-evaluation step, ML model 180 generates an evaluation dataset 210 that can then be used to evaluate the fairness of ML model 180. The evaluation dataset 210 includes an ordered tubular input dataset X that includes respective attribute tensors xᵢ, i ∈ {1, ...,N} for each individual entity i in a group of N individual entities. As noted above, the attribute tensor xᵢ for each entity i is an ordered set of attribute values xᵢ = {x_{i,1}, ...,x_{i,L}}, with each attribute value indicating a value for the individual entity i for a respective attribute in a set of attributes {AT_1, ... , AT_L}. The attributes included in the set of attributes {AT_1, ... , AT_L} are common for all of the attribute tensors xᵢ,i ∈ {1, ...,N}. Evaluation dataset 210 also includes the respective prediction outcomes ŷᵢ generated by the ML model 180 for each of the N individual entities i based on the respective attribute tensors xᵢ.

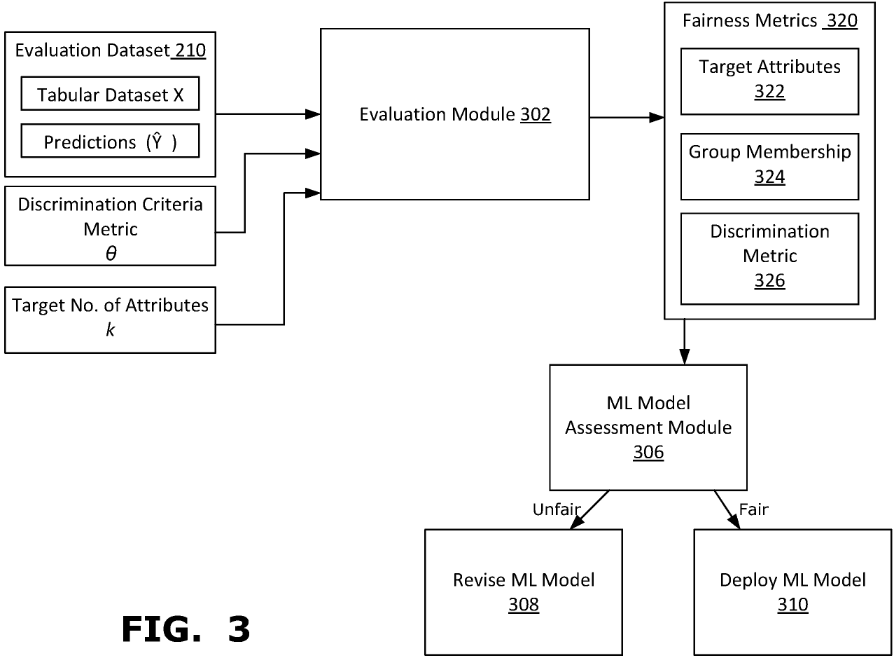

With reference to FIG. 3, according to example aspects of the disclosure, evaluation dataset 210 is provided as input to an ML model fairness evaluation module 302 (hereinafter evaluation module 302). In the illustrated embodiment, the evaluation module 302 can also receive as inputs: a discrimination threshold metric θ and a target number of attributes k. In some examples, discrimination threshold metric θ and target number of attributes k may be set to default values. Evaluation module 302 generates, as outputs, as set of fairness metrics 320 that can be used to asses fairness of the ML model 180, including: (i) a subset of the attributes 322 selected from the set of attributes {AT_1, ... , AT_L}, where the attributes included in the subset of attributes 322 are the attributes that have a highest potential discriminatory influence between a first sub-group and a second sub-group of the group of individual entities represented in the evaluation dataset 210; (ii) the membership 324 of the first sub-group and second sub-group; and (iii) a discrimination metric 326 indicating a numeric level of discrimination between the first sub-group and second sub-group. The subset of attributes 322 includes up to the target number of attributes k (i.e. the subset of attributes includes a maximum of k attributes from the set of set of attributes {AT_1, ... , AT_L}.

As described in greater detail below, the evaluation module 302 runs an optimization process on the evaluation dataset 210, to compute fairness metrics 320. As used herein, optimization process refers to an iterative process that is used to learn fairness metrics 320 to solve a defined optimization problem. In the illustrated example, evaluation module 302 computes respective importance values {w₁,...,w_{L}} (collectively, importance values w) for the attributes in the set of attributes {AT_1, ... , AT_L}. Each respective importance value wⱼ indicates a respective influence a corresponding attribute AT_j in the set of attributes {AT_1, ... , AT_L} has on a probability of the ML model 180 predicting the first outcome (for example a preferred outcome) for any individual entity i based on that individual entity’s ordered set of attribute values xᵢ = {x_{i,1}, ...,x_{i,L}}. In example embodiments, the respective importance values {w₁,...,w_{L}} are each continuous variables within a range of 0 and 1, with higher magnitudes indicating higher levels of influence. The inclusion of a sensitive attribute (e.g., gender identity, weight or age) in the subset of attributes 322 having the highest respective importance values may indicate potentially unfair behavior of the ML model 180. For example, the inclusion of a sensitive attribute in the subset of attributes 322 comprising the pre-defined target number k of the most influential attributes, as ranked based on the respective importance values, can be indicative of a potential discrimination concern. In this regard, in example embodiments, the evaluation module 302 is configured to output, as target attributes 322, the top k attributes and their respective importance values.

The evaluation module 302 is configured to analyze the evaluation dataset 210 to determine the largest possible group of individual entities that is being discriminated against. Such an analysis may for example align with a desire of an organization to identify larger groups that are discriminated so that the organization can maximize overall satisfaction in their customer or employee base. The evaluation module 302 performs this analysis by solving an optimization problem to identify the largest sub-group represented in the evaluation dataset 210 for which the ML model 180 discriminates and identify the combination of attributes (target attributes 322) that are most influential in defining that largest sub-group.

In the illustrated example, the evaluation module 302 performs this function by computing the importance values {w₁, ...,w_{L}} with an objective of maximizing sizes of both a first sub-group (for example a non-discriminated group) and a second sub-group (for example a discriminated group) of the group of entities. In order to do this, the evaluation module 302 optimally divides the group of entities into first and second sub-groups of maximum sizes that also achieve a pre-defined discrimination criteria. In an example, the discrimination criteria is the discrimination threshold metric θ. The sizes of the first sub-group and second sub-group are maximized to find the largest size sub-groups for which a difference between: (i) a relative quantity of entities included within the first sub-group having the first outcome predicted by the ML model 180 and (ii) a relative quantity of entities included within the second sub-group having the first outcome predicted by the ML model 180 achieves the pre-defined discrimination criteria.

In a particular example, the evaluation module 302 performs the above optimization by solving the following optimization problem formulation:

$${max}_{\text{w}} \left({\sum }_{i = 1}^{N} σ \left({x}_{i}\right)\right) \left({\sum }_{i = 1}^{N} \left(1 - σ \left({x}_{i}\right)\right)\right)$$

$$s . t . P \left({G}_{i} = 1\right) = σ \left({x}_{i}\right) = \frac{1}{1 + {e}^{- {w}^{T} x} i} ∀ i = 1 , … , N$$

$$\left|\frac{{\sum }_{i = 1}^{N} {\hat{y}}_{i} σ \left({x}_{i}\right)}{{\sum }_{i = 1}^{N} σ \left({x}_{i}\right)} - \frac{{\sum }_{i = 1}^{N} \hat{{y}_{i}} \left(1 - σ \left({x}_{i}\right)\right)}{{\sum }_{i = 1}^{N} \left(1 - σ \left({x}_{i}\right)\right)}\right| \geq θ$$

$${\left‖w\right‖}_{0} \leq k$$

Where:

w is the set of respective importance values {w₁, ...,w_{L}} for the attributes {AT_1, ... , AT_L}; the respective importance values {w₁,...,w_{L}} are learned while solving the optimization problem and denote the contribution of the respective attributes to discrimination.

k is the target number of attributes (for example k may be an integer value within a range of 2 to 5 in some examples).

N is the number of individual entities included in the evaluation dataset 210.

xᵢ is the ordered set of attributes for individual entity i.

P(Gᵢ = 1) = σ(xᵢ) is the probability of an individual entity i being assigned to the first sub-group G = 1.

1 - σ(xᵢ) is the probability of individual entity i being assigned to the second sub-group G = 2.

$${\sum }_{i = 1}^{N} σ \left({x}_{i}\right)$$

is the size of the first sub-group G = 1.

$${\sum }_{i = 1}^{N} \left(1 - σ \left({x}_{i}\right)\right)$$

is the size of the second sub-group G = 2.

ŷᵢ is the predicted outcome by ML model 180 for individual entity i (e.g., ŷᵢ = 1 corresponds to a first or preferred outcome; ŷᵢ = 0 corresponds to a second or non-preferred outcome.

$$\frac{{\sum }_{i = 1}^{N} {\hat{y}}_{i} σ \left({x}_{i}\right)}{{\sum }_{i = 1}^{N} σ \left({x}_{i}\right)}$$

is the ratio of the number of entities included in the first sub-group G = 1 for which the ML model 180 has predicted the first outcome ŷᵢ = 1 to the total number of entities included in first sub-group G = 1.

$$\frac{{\sum }_{i = 1}^{N} \hat{{y}_{i}} \left(1 - σ \left({x}_{i}\right)\right)}{{\sum }_{i = 1}^{N} \left(1 - σ \left({x}_{i}\right)\right)}$$

is the ratio of the number of entities included in second sub-group G = 2 for which the ML model 180 has predicted the first outcome ŷᵢ = 1 to the total number of entities included in second sub-group G = 2.

θ is the discrimination threshold metric (for example θ may be real value within a range of 0 to 1).

Equation (1) maximizes the size of the sub-group that is discriminated against while also maximizing the size of the sub-group that do not belong to the first sub-group. Equation (2) uses a sigmoid function, incorporating matrix multiplication of the set w of importance values w with the ordered set attribute tensor xᵢ for individual entity i to predict the probability of an individual entity i being assigned to the first sub-group G = 1. Equation (3) sets a constraint that ensures that the discrimination between the first sub-group and the second subgroup meets or exceeds the discrimination threshold metric θ. Equation (4) specifies the maximum number of attributes (e.g., number of k of target attributes 322) that are used to identify discrimination.

The optimization problem formulation represented in equations (1) to (4) is directed to identifying a large sub-group of individual entities for which the ML model 180 discriminates by more than the pre-determined discrimination threshold metric θ. In the illustrated example, the discrimination threshold metric θ corresponds to a demographic parity value. As used in this disclosure, demographic parity can mean the following: Given two groups of the data, the demographic parity is defined as the absolute difference between the probabilities of the ML model of predicting a favorable outcome for the two groups. A favorable outcome is the preferred outcome given the prediction task, for example, in situations where a lending institution is deciding on giving out a loan to bank customers, receiving the loan is the favorable outcome. If demographic parity is zero, then the ML model can be considered completely fair with respect to the metric as statistically members of both groups are equally likely to receive favorable outcome.

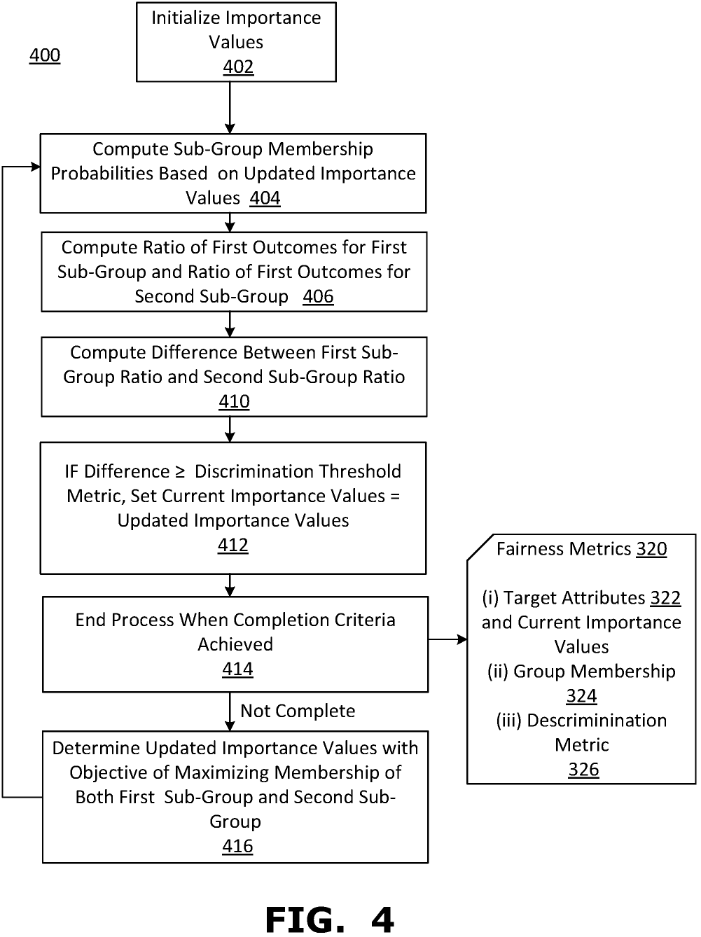

FIG. 4 is a flow chart representation of an example of an iterative optimization process 400 performed by the evaluation module 302 to solve the optimization problem formulation of equations (1) to (4). As indicated, the optimization process 400 begins at block 402. At block 402, the set w of respective importance values {w₁, ...,w_{L}} for the set of attributes {AT_1, ... , AT_L} is initialized. For example, values from 0 to 1 may be randomly sampled from a distribution, such as a normal distribution, and assigned as respective initial values to each of the respective importance values {w₁, ...,w_{L}}. The initialized set w of respective importance values is used as the updated set w of importance values for a first iteration of the optimization process 400. The initialized set w of respective importance values can also be used to populate a current set w′ of importance values.

At indicated at block 404, a membership probability is then computed for each of the N entities based on the updated set w of importance values as per Equation (2).

As indicated at block 406, (i) a first metric is computed indicating a relative quantity of members of the first sub-group for which the ML model 180 has predicted the first outcome (e.g., a ratio of first outcomes for the first sub-group as per

$$\left(\frac{{\sum }_{i = 1}^{N} {\hat{y}}_{i} σ \left({x}_{i}\right)}{{\sum }_{i = 1}^{N} σ \left({x}_{i}\right)}\right)$$

and (ii) a second metric is computed indicating a relative quantity of members of the second sub-group for which the ML model 180 has predicted the first outcome (e.g., a ratio of first outcomes for the second sub-group as per

$$\left(\frac{{\sum }_{i = 1}^{N} \hat{{y}_{i}} \left(1 - σ \left({x}_{i}\right)\right)}{{\sum }_{i = 1}^{N} \left(1 - σ \left({x}_{i}\right)\right)}\right) .$$

As indicated at block 410, a difference between the ratio of first outcomes for the first subgroup and the first outcomes for the second subgroup is computed. In the illustrated example, this difference is a discrimination metric that indicates a numeric level of discrimination between the first sub-group and second sub-group, namely a demographic parity metric.

As indicated at block 412, a determination is then made to confirm that the discrimination metric computed at block 410 achieves the discrimination threshold metric θ. This regard, blocks 406, 410 and 412 collectively implement Equation (3). When the discrimination metric computed at block 410 achieves the discrimination threshold metric θ, then the current set w′ of importance values are replaced with the updated set w of importance values.

As indicated at block 414, a determination is made if optimization process 400 has achieved a completion criteria. In some examples, the completion criteria could be achieving a predetermined number of iterations of blocks 404 to 416 of the optimization process 400. In some examples completion criteria could be based on a finding that the respective sizes of the first sub-group and second sub-group are not changing more than a threshold amount in successive iterations (e.g., maximum group sizes have stabilized). In some examples the completion criteria can be based on at one of a plurality of completion metrics being reached, for example either a predetermined number of iterations or a finding that the respective sizes of the first sub-group and second sub-group have stabilized.

If the completion criteria has not been achieved, as indicated at block 416 updated importance values are then computed to use for a next iteration, with an objective of maximizing group sizes of both the first sub-group and second sub-group, as indicated in Equation (1). By way of example a loss may be computed using a loss function that is configured to maximize Equation (1) while achieving the discrimination threshold metric θ, and the computed loss used to update the importance values

Referring again to block 414, when the completion criteria is achieved, then the evaluation module 302 outputs fairness metrics 320. The subset of attributes 322 includes attributes that correspond to the attributes that have the five highest importance values in the current set w′ of importance values. The group membership 324 will correspond to the first sub-group membership probabilities based on the current set w′ of importance values. The discrimination metric 326 will correspond to the difference between the first outcome prediction ratios based on the first sub-group and second sub-group memberships specified in group membership 324.

In some examples, the evaluation module 302 may analyze an evaluation dataset 210 and not be able to find a valid solution that satisfies the discrimination constraint (e.g., the evaluation model is unable to identify a combination of sub-groups that result is a discrimination metric that achieves the discrimination metric threshold θ). In such cases, the evaluation module 302 can output an indication that the ML model 180 has not identified a solution where the discrimination exceeds the discrimination metric threshold θ.

Optimization process 400 can be summarized as having the following actions that are repeated until a predefined completion criteria is achieved: (i) computing membership of a first sub-group and a second sub-group of the group of entities based on predicting, for each entity in the group of entities, a membership probability that the entity belongs to the first sub-group rather than the second sub-group, the membership probability for each entity being based on the ordered set of attribute values for the entity and the respective importance values for the attributes; (ii) computing, for the first sub-group, a first metric indicating a relative quantity of members of the first sub-group for which the machine learning model has predicted the first outcome; (iii) computing, for the second sub-group, a second metric indicating a relative quantity of members of the second sub-group for which the machine learning model has predicted the first outcome; and (iv) adjusting the respective importance values with an objective of maximizing the membership of both the first sub-group and the second sub-group with a difference between the first metric and the second metric achieving a pre-defined discrimination threshold metric.

It will be appreciated that in illustrated examples, evaluation module 302 is configured to efficiently evaluate, based on the optimization problem formulation represented in equations (1) to (4), whether ML model 180 discriminates against a large group of entities, and if so, indicate the membership of the discriminated group, identify the attributes that are causing the ML model 180 to discriminate, and a value of discrimination happening against the identified discriminated group. By applying the demographic parity fairness metric, evaluation module 302 is able to identify (1) a large group for which the ML model 180 discriminates and (2) the combination of attributes that define the groups and cause the ML model 180 to discriminate. Evaluation module 302 obtains the results through an efficient, continuous optimization, solution that can be efficiently scaled to large datasets with large number of attributes.

When compared to known methods for evaluating fairness of a ML model, the disclosed methods for evaluating fairness of a ML model may, in some scenarios, enable a computer system to generate a more optimal solution, thereby enabling the computer system to operate in an improved manner. In some examples, fewer computational resources (for example, processor time) may be required for evaluating the fairness of a ML model when compared to known methods for evaluating fairness of a ML model as the optimization problem is treated as a continuous optimization problem rather than a discrete optimization problem. Additionally, s the disclosed evaluation module 302 is able to identify potentially discriminating categories without being pre-instructed to focus on a sub-group of categories, thereby reducing an overall number of computer resources required to accurately identify attributes that cause discrimination above a threshold level.

The disclosed evaluation module 302 may, in some scenarios, provide advantages over other known fairness evaluation solutions, including: the continuous optimization applied by evaluation module 302 efficiently identify discrimination without requiring an exponential search over attributes; evaluation module 302 can support continuous attributes and can identify their contribution to discrimination; and the optimization process run by evaluation module 302 may yield more optimal solutions as compared to other fairness evaluation solutions.

Referring again to FIG. 3, in at least some examples, evaluation module 302 can be hosted on a cloud computing system and offered as a service that is accessible by organizations through the Internet. A member of an organization can provide evaluation datasets 210 (which as noted above can include an input dataset X and the predicted outcomes ŷ of the model being evaluated), to the elevation module 302 through a user interface of a client computing device to evaluate their respective ML models for evidence of probable discrimination. Alternatively, in place of evaluation dataset 210, a member of an organization can provide input dataset X and the machine learning model 180 that is to be evaluated, to the elevation module 302. A member of an organization can use a user interface of a client computing device to make a request to the service with the appropriate inputs (evaluation dataset 210, discrimination criteria metric θ and target number of attributes k). A client device can communicate with the model fairness evaluation module 302 through the Internet and the model fairness evaluation module 302 produces the evidence of discrimination on the cloud computing system in the form of outputs described above (e.g., fairness metrics 320) The outputs are sent by the service through Internet back to the organization’s client device where the user interface of client device can display the results of fairness evaluation.

The cloud computing system hosting the service can include multiple computing devices such as servers, cluster of servers or virtual machines that provide extensive computation power in the form of specialized processing units. In some cases, the cloud hosting the service may also host a service for training a ML model to allow organizations to train new ML models. In this case, the organization does not need to need to provide a ML model’s predictions to the service for training the ML model in order to perform a fairness prediction as the service for training ML model can automatically extract predictions after the ML model has been trained. After the ML model has been trained and the fairness evaluation has been completed, the organization’s client device can then be sent the outputs described above via the Internet for display on the user interface of the client device.

In an alternative configuration, the evaluation module 302 may be provided to an organization as computer program product (software) that can be run on any of the organization’s computer systems (e.g. physical machines or virtual machines). In such cases, the computer systems of an organization can run the evaluation module 302 locally to evaluate fairness of an ML model. This provides a way to the organization to avoid sharing potentially confidential evaluation dataset and other information with a third party cloud computing system.

As indicated in FIG. 3, in some examples the fairness metrics 320 may be subject to further analysis, for example by an ML model assessment module 306. In one example, the ML model assessment module 306 may present the fairness metrics 320 in a user interface displayed on a display of a computer system such that a human administrator can determine if any of the attributes included in the subset of attributes 322 may be problematic, given their respective importance values, the group membership 324 of the first and second sub-groups and the value of the discrimination metric 326. As a result of such assessment, the human administrator may interact with the user interface to indicate that the ML model 180 is unfair. For example, the human administrator may select a user interface element, which when selected, indicates to the ML model assessment module 306 that the ML model is unfair in which case the ML assessment module 306 sends an instruction, for example, to a ML training service host on a cloud computing system, to retrain the ML model 180 (block 308), or may be deemed to be fair, in which case the he ML assessment module 306 sends an indication that the ML model 180 can be deployed (block 310).

In some examples, ML model assessment module 306 may include automated features to assist in assessing ML models. For example, some cases of discrimination may be flagged for extra consideration. For example, flagging criteria could be set such that when the fairness metrics 320 indicated that a particular attribute exceeds a certain level of importance and a corresponding discrimination metric exceeds a predetermined value then a special indication of unfairness could be generated in respect of the corresponding ML model.

Although the evaluation module 302 has been described in the context of detecting unfairness regarding predictions made in respect of human individual entities, the evaluation module 302 could also be configured to analyze in a context in which an ML model makes predictions in respect of other entities that are not limited to individuals entities, including for example organizational entities that include groups of individuals. By way of example, a ML model may be trained to assess whether a non-government organization (NGO) receives grant funding, and it may be desirable to assess if the ML model treats some NGOs unfairly based on sensitive attributes.

In an alternative example embodiment, rather than determine the largest possible group of entities that is being discriminated against, evaluation module 302 is instead configured to analyze the evaluation dataset 210 to determine the largest discrimination possible when provided with group size constraint. Such an analysis may for example align with a desire of an organization to identify a sufficiently large group that is the most discriminated. In such a case, the evaluation module 302 is configured to perform an optimization process to solve an alternative optimization problem to identify the sub-group represented in the evaluation dataset 210 that achieves a minimum size constraint and for which the ML model 180 discriminates the most, and identify the combination of attributes (target attributes 322) that are most influential in defining that most discriminated sub-group.

In the illustrated example embodiment, the evaluation module 302 is configured to perform an optimization process to solve an alternative optimization problem to identify the sub-group represented in the evaluation dataset 210 that achieves a minimum size constraint and for which the ML model 180 discriminates the most, and identify the combination of attributes (target attributes 322) that are most influential in defining that most discriminated sub-group by computing the importance values {w₁, ...,w_{L}} with an objective of maximizing a discrimination metric (for example, a demographic parity value) between a first sub-group (for example a non-discriminated group) and a second sub-group (for example a discriminated group) of the group of entities, while also ensuring that a pre-defined group size constrained is met.

In a particular example, the evaluation module 302 is configured to perform the optimization process by solving the following alternative optimization problem formulation:

$${max}_{\text{w}} \left|\frac{{\sum }_{i = 1}^{N} {\hat{y}}_{i} σ \left({z}_{i}\right)}{{\sum }_{i = 1}^{N} σ \left({z}_{i}\right)} - \frac{{\sum }_{i = 1}^{N} \hat{{y}_{i}} \left(1 - σ \left({z}_{i}\right)\right)}{{\sum }_{i = 1}^{N} \left(1 - σ \left({z}_{i}\right)\right)}\right|$$

$$s . t . P \left({G}_{i} = 1\right) = σ \left({z}_{i}\right) = σ \left({w}^{T} {x}_{i}\right) \frac{1}{1 + {e}^{- {w}^{T} x} i} ∀ i = 1 , … , N$$

$$\frac{1}{N} {\sum }_{i = 1}^{N} σ \left({z}_{i}\right) \geq θ$$

$$\frac{1}{N} {\sum }_{i = 1}^{N} \left(1 - σ \left({z}_{i}\right)\right) \geq θ$$

$${\left‖w\right‖}_{0} \leq k$$

Where:

w is the set of respective importance values {w₁, ...,w_{L}} for the set of attributes {AT_1, ... , AT_L}; the respective importance values {w₁,...,w_{L}} are learned while solving the optimization problem and denote the contribution of respective attributes in the set of attributes to discrimination.

k is the target number of attributes (for example k may be an integer value within a range of 2 to 5 in some examples).

N is the number of individual entities included in the evaluation dataset 210.

xᵢ is the ordered set of attributes for individual entity i.

P(Gᵢ = 1) is the probability of an individual entity i being assigned to the first sub-group G = 1.

1 - _{σ}(zᵢ) is the probability of individual entity i being assigned to the second sub-group G = 2.

$${\sum }_{i = 1}^{N} σ \left({z}_{i}\right)$$

is the size of the first sub-group G = 1.

$${\sum }_{i = 1}^{N} \left(1 - σ \left({z}_{i}\right)\right)$$

is the size of the second sub-group G = 2.

ŷᵢ is the predicted outcome generated by ML model 180 for individual entity i (e.g., ŷᵢ = 1 corresponds to a first or preferred outcome; ŷᵢ = 0 corresponds to a second or non-preferred outcome.

$$\frac{{\sum }_{i = 1}^{N} {\hat{y}}_{i} σ \left({z}_{i}\right)}{{\sum }_{i = 1}^{N} σ \left({z}_{i}\right)}$$

is the ratio of the number of entities included in the first sub-group G = 1 for which the ML model 180 has predicted the first outcome ŷᵢ = 1 to the total number of entities included in first sub-group G = 1.

$$\frac{{\sum }_{i = 1}^{N} \hat{{y}_{i}} \left(1 - σ \left({z}_{i}\right)\right)}{{\sum }_{i = 1}^{N} \left(1 - σ \left({z}_{i}\right)\right)}$$

is the ratio of the number of entities included in second sub-group G = 2 for which the ML model 180 has predicted the first outcome ŷᵢ = 1 to the total number of entities included in second sub-group G = 2.

θ is a relative sub-group size threshold metric, and in particular a threshold size ratio of the number of entities included in a sub-group relative to the total number N of entities.

Equation (5) maximizes a discrimination metric (for example, a demographic parity value) between a first sub-group (for example a non-discriminated group) and a second sub-group (for example a discriminated group) of the group of entities. Equation (6) uses a sigmoid function, incorporating matrix multiplication of the set w of importance values w with the ordered set attribute tensor xᵢ for individual entity i to predict the probability of an individual entity i being assigned to the first sub-group G = 1. Equations (7) and (8) set a constraint that ensures that the relative sizes of both the first sub-group and the second sub-group meet or exceeds a minimum relative sub-group size threshold metric θ. Equation (9) specifies the maximum number of attributes (e.g., number of k of target attributes 322) that are used to identify discrimination.

The optimization problem formulation represented in equations (5) to (8) is directed to identifying a sub-group of individual entities of a minimum relative size against which the ML model 180 discriminates the most. In the illustrated example embodiment, the discrimination value that is maximized corresponds to a demographic parity value.

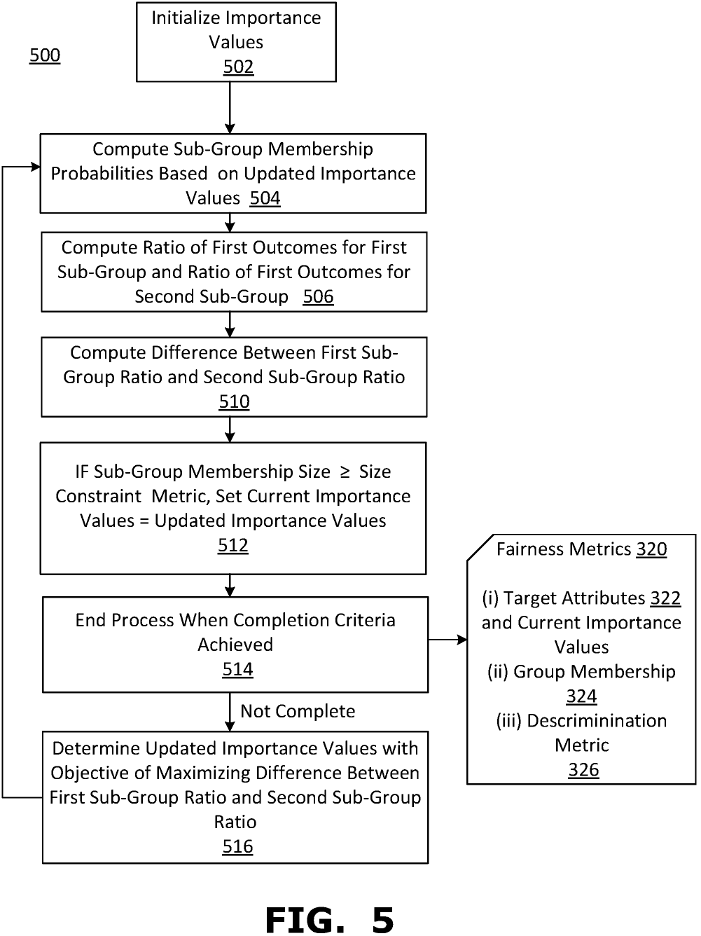

FIG. 5 is a flow chart representation of an example of an iterative optimization process 500 performed by the evaluation module 302 to solve the optimization problem formulation of equations (5) to (8). As indicated at block 502, the set w of respective importance values {w₁,...,w_{L}} for the set of attributes {AT_1, ... , AT_L} is initialized. For example, values from 0 to 1 may be randomly sampled from a distribution, such as a normal distribution, and assigned as respective initial values to each of the respective importance values {w₁,...,w_{L}}. The initialized set w of respective importance values is used as the updated set w of importance values for a first iteration of the optimization process 500. The initialized set w of respective importance values can also be used to populate a current set w′ of importance values.

At indicated at block 504, a membership probability is then computed for each of the N entities based on the updated set w of importance values as per Equation (6).

As indicated at block 506, (i) a first metric is computed indicating a relative quantity of members of the first sub-group for which the ML model 180 has predicted the first outcome (e.g., a Ratio of First Outcomes for the First Sub-Group as per

$$\left(\frac{{\sum }_{i = 1}^{N} {\hat{y}}_{i} σ \left({z}_{i}\right)}{{\sum }_{i = 1}^{N} σ \left({z}_{i}\right)}\right)$$

and (ii) a second metric is computed indicating a relative quantity of members of the second sub-group for which the ML model 180 has predicted the first outcome (e.g., a ratio of First Outcomes for the Second Sub-Group as per

$$\left(\frac{{\sum }_{i = 1}^{N} \hat{{y}_{i}} \left(1 - σ \left({z}_{i}\right)\right)}{{\sum }_{i = 1}^{N} \left(1 - σ \left({z}_{i}\right)\right)}\right) .$$

As indicated at block 510, a difference between the ratio of first outcomes for the first subgroup and the second subgroup is calculated. In the illustrated example, this difference is a discrimination metric that indicates a numeric level of discrimination between the first sub-group and second sub-group, namely a demographic parity metric.

As indicated at block 512, a determination is then made to confirm that the relative sizes of each sub-group achieves size constraint threshold metric θ, as per equations (7) and (8), based on the sub-group membership determined at block 504. For cases where the sub-group sizes achieve the size constraint threshold metric θ, then the current set w′ of importance values are replaced with the updated set w of importance values.

As indicated at block 514, a determination is made if optimization process 500 has achieved a completion criteria. In some examples, the completion criteria could be achieving a predetermined number of iterations of Blocks 504 to 516 of the optimization process 500. In some examples completion criteria could be based on a finding that the discrimination metric (i.e., the difference Between First Sub-Group Ratio of first outcomes and Second Sub-Group Ratio of first outcomes) is not changing more than a threshold amount in successive iterations. In some examples the completion criteria can be based on at one of a plurality of completion metrics being reached, for example either a predetermined number of iterations or a finding that the discrimination metric has stabilized.

If the completion criteria has not been achieved, as indicated at block 516, updated importance values are then calculated to use for a next iteration, with an objective of maximizing membership the discrimination metric, as indicated in Equation (1). By way of example a loss may be calculated using a loss function that is configured to maximize Equation (1) while achieving the sub-group membership size constraint metric and the calculated loss used to update the importance values as part of a backpropagation step.

Referring again to block 514, when the completion criteria is achieved, then the evaluation module 302 outputs fairness metrics 320. The top k target attributes 322 correspond to the attributes that have the five highest importance values in the current set w′of importance values. The group membership 324 will correspond to the first sub-group membership probabilities calculated based on the current set w′of importance values. The discrimination metric 326 will correspond to the difference between the first outcome prediction ratios based on the first sub-group and second sub-group memberships specified in group membership 324.

In some examples, the evaluation module 302 may evaluate an evaluation dataset 210 in which there is no combination of sub-groups that result is a discrimination metric that achieves the size constraint threshold metric θ. In such cases, the evaluation module 302 can output an indication that the ML model 180 does not include any qualifying discrimination.

Optimization process 500 can be summarized as having the following actions that are repeated until a predefined completion criteria is achieved: (i) computing membership of a first sub-group and a second sub-group of the group of entities based on predicting, for each entity in the group of entities, a membership probability that the entity belongs to the first sub-group rather than the second sub-group, the membership probability for each entity being based on the ordered set of attribute values for the entity and the respective importance values for the attributes; (ii) computing, for the first sub-group, a first metric indicating a relative quantity of members of the first sub-group for which the machine learning model has predicted the first outcome; (iii) computing, for the second sub-group, a second metric indicating a relative quantity of members of the second sub-group for which the machine learning model has predicted the first outcome; and (iv) adjusting the respective importance values with an objective of maximizing a discrimination metric that corresponds to the difference between the first metric and the second metric, while achieving a pre-defined relative subgroup size threshold metric.

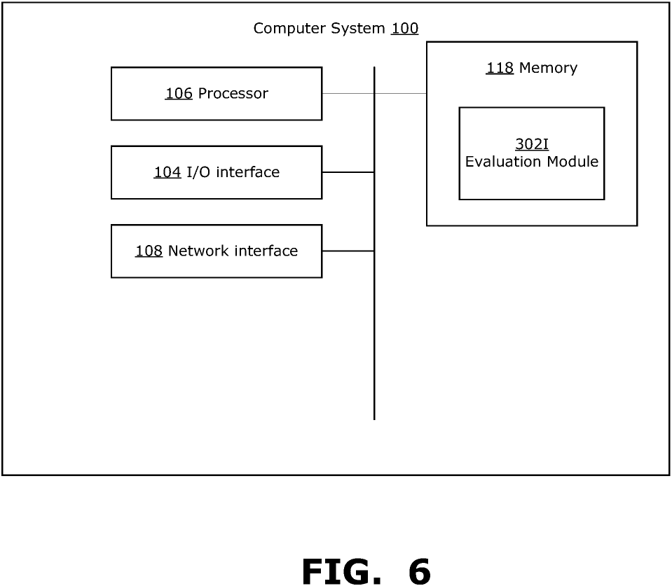

Referring to FIG. 6, a block diagram of a computer system 100 that can be used to implement systems and methods of the present disclosure, including the evaluation module 302, is shown. Although an example embodiment of the computer system 100 is shown and discussed below, other embodiments may be used to implement examples disclosed herein, which may include components different from those shown. Although FIG. 5 shows a single instance of each component, there may be multiple instances of each component shown.

The computer system 100 includes one or more processors 106, such as a central processing unit, a microprocessor, an application-specific integrated circuit (ASIC), a field-programmable gate array (FPGA), a dedicated logic circuitry, a tensor processing unit, a neural processing unit, a dedicated artificial intelligence processing unit, or combinations thereof. The computer system 100 may also includes one or more input/output (I/O) interfaces 104. The computer system 100 includes one or more network interfaces 108 for wired or wireless communication with a network (e.g., an intranet, the Internet, a peer-to-peer (P2P) network, a wide area network (WAN) and/or a local area network (LAN)) or other node. The network interface(s) 108 may include wired links (e.g., Ethernet cable) and/or wireless links (e.g., one or more antennas) for intra-network and/or inter-network communications.

The computer system 100 includes one or more memories 118, which may include volatile and non-volatile memories and electronic storage elements (e.g., a flash memory, a random access memory (RAM), read-only memory (ROM), hard drive). The non-transitory memory(ies) 118 may store instructions for execution by the processor(s) 106, such as to carry out examples described in the present disclosure. The memory(ies) 118 may store, in a non-volatile format, other non-volatile software instructions, such as for implementing an operating system and other applications/functions. The software instructions may for example include evaluation module instructions 302I that when executed by the one or more processor(s) 106, configure the computer system 100 to implement the evaluation module 302.

Certain adaptations and modifications of the described embodiments can be made. The methods utilize the principle that the input space has more area or region as compared to the visual space of a display. The above discussed embodiments are considered to be illustrative and not restrictive.

1. A computer-implemented method for evaluating a machine learning model, comprising:
receiving an evaluation dataset for the machine learning model, the evaluation dataset comprising, for each entity in a group of entities: (i) an ordered set of attribute values for the entity, each attribute value corresponding to a respective attribute in a set of attributes that is common for all of the entities in the group of entities, and (ii) an outcome prediction generated for the entity by the machine learning model based on the ordered set of attribute values for the entity, wherein the outcome prediction generated for each entity is either a first outcome or a second outcome;
computing, based on the evaluation dataset, using an optimization process, respective importance values for the attributes, the respective importance values indicating respective influences of the attributes on a probability of the machine learning model predicting a first outcome; and
outputting at least some of the importance values for the attributes as an evaluation metric indicating a fairness of the machine learning model.

2. The method of claim 1 wherein the respective importance values are computed with an objective of maximizing sizes of both a first sub-group and a second sub-group of the group of entities such that a discrimination metric for the machine learning model between the first sub-group and the second sub-group achieves a pre-defined discrimination criteria, wherein membership of the first sub-group and the second sub-group is based on the respective importance values.

3. The method of claim 2 wherein the first sub-group excludes any entities that are members of the second sub-group and the first sub-group and second sub-group collectively include all entities in the group of entities.

4. The method of claim 1 wherein computing the respective importance values comprises:
initializing the respective importance values;
repeating the optimization process until a predefined completion criteria is achieved, the optimization process comprising:
(i) computing membership of a first sub-group and a second sub-group of the group of entities based on predicting, for each entity in the group of entities, a membership probability that the entity belongs to the first sub-group rather than the second sub-group, the membership probability for each entity being based on the ordered set of attribute values for the entity and the respective importance values for the attributes;
(ii) computing, for the first sub-group, a first metric indicating a relative quantity of members of the first sub-group for which the machine learning model has predicted the first outcome;
(iii) computing, for the second sub-group, a second metric indicating a relative quantity of members of the second sub-group for which the machine learning model has predicted the first outcome; and
(iv) updating the respective importance values with an objective of maximizing the membership of both the first sub-group and the second sub-group with a difference between the first metric and the second metric achieving a pre-defined discrimination threshold metric.

5. The method of claim 4 comprising, when the predefined completion criteria is achieved:
outputting a final membership of the first sub-group and the second sub-group that includes an identification of the entities of the first sub-group and the second sub-group, respectively; and
outputting, as a discrimination metric, the difference between the first metric and the second metric for the final membership.

6. The method of claim 1 wherein outputting at least some of the importance values comprises outputting a subset of the importance values that consist of a predefined number of the importance values ranked according to highest value, the method further comprising receiving the predefined number as an input.

7. The method of claim 1 wherein the importance values are continuous variables on a predefined continuous scale.

8. The method of claim 1 wherein the attributes include both discrete variable attributes and continuous variable attributes.

9. The method of claim 1 wherein the evaluation dataset includes a tabular data structure, with the entities in the group of entities represented in a respective row, and each attribute represented in a respective column.

10. The method of claim 1 wherein the entities are set of human individuals, the attributes correspond to attributes of the human individuals, the first outcome is a preferred outcome for the human entities, the second outcome is a non-preferred outcome, and the method further comprises:
determining, based on the output importance values for the attributes, if the machine learning model unfairly discriminates between human individuals based on one or more of the attributes; and
when the machine learning model is determined to unfairly discriminate, outputting an indication thereof.

11. The method of claim 1 wherein the respective importance values are computed with an objective of maximizing a discrimination metric that corresponds to a difference between a relative quantity of entities of the group of entities included within a first sub-group having the first outcome predicted by the machine learning model and a relative quantity of entities included within a second sub-group having the first outcome predicted by the machine learning, wherein membership of the first sub-group and the second sub-group is based on the respective importance values.

12. The method of claim 1 wherein computing the respective importance values comprises:
initializing the respective importance values;
repeating the optimization process until a predefined completion criteria is achieved, the optimization process comprising:
(i) computing membership of a first sub-group and a second sub-group of the group of entities based on predicting, for each entity in the group of entities, a membership probability that the entity belongs to the first sub-group rather than the second sub-group, the membership probability for each entity being based on the ordered set of attribute values for the entity and the respective importance values for the attributes;
(ii) computing, for the first sub-group, a first metric indicating a relative quantity of members of the first sub-group for which the machine learning model has predicted the first outcome;
(iii) computing, for the second sub-group, a second metric indicating a relative quantity of members of the second sub-group for which the machine learning model has predicted the first outcome; and
(iv) updating the respective importance values with an objective of maximizing the difference between the first metric and the second metric with membership of both the first sub-group and the second sub-group achieving a pre-defined size constraint.

13. The method of claim 12 comprising, when the predefined completion criteria is achieved:
outputting a final membership of the first sub-group and the second sub-group that includes an identification of the entities of the first sub-group and the second sub-group, respectively; and
outputting, as the discrimination metric, the difference between the first metric and the second metric for the final membership.

14. A system for evaluating a machine learning model, comprising:
one or more processors;
one or more memories storing executable instructions that when executed by the one or more processors cause the system to process an evaluation dataset for the machine learning model, the evaluation dataset comprising, for each entity in a group of entities: (i) an ordered set of attribute values for the entity, each attribute value corresponding to a respective attribute in a set of attributes that is common for all of the entities in the group of entities, and (ii) an outcome prediction generated for the entity by the machine learning model based on the ordered set of attribute values for the entity, wherein the outcome prediction generated for each entity is either a first outcome or a second outcome;
wherein the executable instructions, when executed by the one or more processors, cause the system to process the evaluation dataset by:
computing, based on the evaluation dataset, using an optimization process, respective importance values for the attributes, the respective importance values indicating respective influences of the attributes on a probability of the machine learning model predicting a first outcome; and
outputting at least some of the importance values for the attributes as an evaluation metric indicating a fairness of the machine learning model.

15. The system of claim 14 wherein the respective importance values are computed with an objective of maximizing sizes of both a first sub-group and a second sub-group of the group of entities such that a discrimination metric for the machine learning model between the first sub-group and the second sub-group achieves a pre-defined discrimination criteria, wherein membership of the first sub-group and the second sub-group is based on the respective importance values.

16. The system of claim 14 wherein computing the respective importance values comprises:
initializing the respective importance values;
repeating the optimization process until a predefined completion criteria is achieved, the optimization process comprising:
(i) computing membership of a first sub-group and a second sub-group of the group of entities based on predicting, for each entity in the group of entities, a membership probability that the entity belongs to the first sub-group rather than the second sub-group, the membership probability for each entity being based on the ordered set of attribute values for the entity and the respective importance values for the attributes;
(ii) computing, for the first sub-group, a first metric indicating a relative quantity of members of the first sub-group for which the machine learning model has predicted the first outcome;
(iii) computing, for the second sub-group, a second metric indicating a relative quantity of members of the second sub-group for which the machine learning model has predicted the first outcome; and
(iv) updating the respective importance values with an objective of maximizing the membership of both the first sub-group and the second sub-group with a difference between the first metric and the second metric achieving a pre-defined discrimination threshold metric.

17. The system of claim 14 wherein outputting at least some of the importance values comprises outputting a subset of the importance values that consist of a predefined number of the importance values ranked according to highest value, the importance values are continuous variables on a predefined continuous scale, and the attributes include both discrete variable attributes and continuous variable attributes, wherein the entities are set of human individuals, the attributes correspond to attributes of the human individuals, the first outcome is a preferred outcome for the human entities, the second outcome is a non-preferred outcome, and the system is caused to further process the evaluation dataset by:
determining, based on the output importance values for the attributes, if the machine learning model unfairly discriminates between human individuals based on one or more of the attributes; and
when the machine learning model is determined to unfairly discriminate, outputting an indication thereof.

18. The system of claim 14 wherein the respective importance values are computed with an objective of maximizing a difference between a relative quantity of entities of the group of entities included within a first sub-group having the first outcome predicted by the machine learning model and a relative quantity of entities included within a second sub-group having the first outcome predicted by the machine learning, wherein membership of the first sub-group and the second sub-group is based on the respective importance values.

19. The system of claim 14 wherein computing the respective importance values comprises:
initializing the respective importance values;
repeating the optimization process until a predefined completion criteria is achieved, the optimization process comprising:
(i) computing membership of a first sub-group and a second sub-group of the group of entities based on predicting, for each entity in the group of entities, a membership probability that the entity belongs to the first sub-group rather than the second sub-group, the membership probability for each entity being based on the ordered set of attribute values for the entity and the respective importance values for the attributes;
(ii) computing, for the first sub-group, a first metric indicating a relative quantity of members of the first sub-group for which the machine learning model has predicted the first outcome;
(iii) computing, for the second sub-group, a second metric indicating a relative quantity of members of the second sub-group for which the machine learning model has predicted the first outcome; and
(iv) updating the respective importance values with an objective of maximizing the difference between the first metric and the second metric with membership of both the first sub-group and the second sub-group achieving a pre-defined size constraint.

20. A non-transitory computer readable medium storing computer executable instructions for evaluating a machine learning model by processing an evaluation dataset for the machine learning model, the evaluation dataset comprising, for each entity in a group of entities: (i) an ordered set of attribute values for the entity, each attribute value corresponding to a respective attribute in a set of attributes that is common for all of the entities in the group of entities, and (ii) an outcome prediction generated for the entity by the machine learning model based on the ordered set of attribute values for the entity, wherein the outcome prediction generated for each entity is either a first outcome or a second outcome, wherein the computer executable instructions, when executed by a computer system, cause the computer system to process the evaluation dataset by:
computing, based on the evaluation dataset, using an optimization process, respective importance values for the attributes, the respective importance values indicating respective influences of the attributes on a probability of the machine learning model predicting a first outcome; and
outputting at least some of the importance values for the attributes as an evaluation metric indicating a fairness of the machine learning model.
